(19) United States
(12) Patent Application Publication
(10) Pub. No.: US 2006/0294170 A1
(43) Pub. Date: Dec. 28, 2006

(54) Diversity receiver device

(76) Inventors: Hidehiro Matsuoka, Yokohama-shi (JP); Hideo Kasami, Yokohama-shi (JP); Makoto Tsuruta, Kawasaki-shi (JP); Yasushi Murakami, Yokohama-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/384,497

(22) Filed: Mar. 21, 2006

(30) Foreign Application Priority Data
Jun. 24, 2005 (JP) 2005-185369

(51) Int. Cl. G06F 17/10

(52) U.S. Cl. 708/300

(57) ABSTRACT

A diversity receiver device includes N antennas to receive OFDM signals, N digital filters to filter the signals received by the N antennas in order to reduce delay spread, K (K≦N) beamforming units configured to subject the filtered signals to a beamforming process by using combining weights, an eigen-decomposition unit configured to subject the filtered signals to eigen-decomposition to generate N eigenvalues, a weight setting unit configured to select K eigenvalues in descending order from the generated N eigenvalues in order to set eigenvectors corresponding to the K eigenvalues to the beamforming units as the combing weight, respectively, K FFT units configured to subject the output signals of the beamforming units to fast Fourier transformation to output FFT signals, and a diversity combining unit configured to combine the FFT signals.

### CROSS-REFERENCE TO RELATED APPLICATIONS

This application is based upon and claims the benefit of priority from prior Japanese Patent Application No. 2005-185369, filed Jun. 24, 2005, the entire contents of which are incorporated herein by reference.

### BACKGROUND OF THE INVENTION

1. Field of the Invention

The present invention relates to a diversity receiver device used in a wireless communication system employing orthogonal frequency-division multiplexing (OFDM).

2. Description of the Related Art

Digital terrestrial television broadcasting in Japan has adopted OFDM as its modulation method in order to increase transmission rates and realize robustness against a delayed interference. In OFDM, data is allocated to orthogonal subcarriers on the frequency axis to perform modulation. At a transmitting side of an OFDM wireless communication system, an inverse fast Fourier transform (IFFT) process is performed in order to transform a frequency domain signal into a time domain signal, while at a receiving side, a fast Fourier transform (FFT) is performed in order to re-transform the time domain into the frequency domain.

In OFDM, subcarriers may be modulated in various modulation schemes. With this, various detection methods, such as coherent detection or differential detection, may be performed at the receiving side.

According to the coherent detection, the transmitting side inserts pilot signals having known amplitude and phase in predetermined positions on a frequency axis and on a time axis. The receiving side extracts the pilot signals, determines the amplitudes and phases of the pilot signals, and detects the amplitude and phase errors between the received signals and the known pilot signals. In accordance with the error of the detection result, equalization of the amplitude and phase of the received signal is performed subcarrier-by-subcarrier.

According to the differential detection, differential encoding is performed at the transmitting side, while differential decoding is performed between the received symbols at the receiving side to demodulate the received signal.

In order to improve the receiving quality in OFDM, space diversity, which uses a plurality of antennas, is quite useful. As one of the space diversities, there is a combining diversity, which combines the signals received at each antenna with a same phase.

As specified in H. Matsuoka and H. Shoki, “Comparison of Pre-FFT and post-FFT processing adaptive arrays for OFDM systems in the presence of co-channel interference”, IEEE PIMRC2003, vol. 2, pp. 1603-1607, September 2003, in such combining diversity, there is a method to combine before FFT, i.e. in the time domain (referred to as pre-FFT combining diversity), and a method to combine after FFT, i.e. in the frequency domain (referred to as post-FFT combining diversity). Matsuoka et al. refers to the combining diversity as an adaptive array process in equivalent terms.

Regarding a pre-FFT combining diversity disclosed by Matsuoka et al., in a multipath propagation model with delay spread, since the result of combining performed by a signal space possessed by an eigenvector does not necessarily maximize the signal to noise ratio (SNR), a diversity gain may not be obtained sufficiently. According to the post-FFT combing diversity disclosed by Matsuoka et al., receiving performance improves due to high diversity gain.

S. Hara, M. Budsabathon and Y. Hara, “A pre-FFT OFDM adaptive antenna array with eigenvector combining”, IEEE International Conference on Communications 2004, vol. 4, pp. 2412-2416, June 2004, suggests a reduction in circuit scale in a post-FFT combining diversity and a method to improve characteristic degradation, which is due to the small number of samples of training signal upon obtaining a diversity weight. When calculating the diversity weight by using the signal after FFT, in order to suppress the interference, it is necessary to perform correlation calculation between a received signal and a known signal even in the case of applying any adaptive algorithm. Accordingly, if the number of samples of the training signal is small, averaging may not be performed sufficiently, meaning that the diversity weight will not be converged to an optimal value.

According to Hara et al., eigen-decomposition is performed prior to FFT, and K (K≦N) eigenvalues including maximum eigenvalue are used to form each different eigenvector beam. The outputs of K eigenvector beams are input to FFT units to perform K-branch subcarrier diversity combining. Eigenvalues exceeding the predetermined threshold are selected as the K eigenvalues. When an angular spread of an incoming signal is large, a second or subsequent eigenvalue may become large. Accordingly, by using not only the maximum eigenvalue but also the second or subsequent eigenvalue, the energy of the desired signal will be utilized efficiently, thereby achieving the similar performance as that of the post-FFT combining diversity.

The post-FFT combining diversity disclosed by Matsuoka et al. has advantage in its receiving performance, while the number of FFTs and diversity combining weights increases as the number of antennas increases. Therefore, in a wireless communication system where thousands of subcarriers are used, such as the digital terrestrial broadcasting, a circuit complexity of a receiver becomes massive.

In the post-FFT combining diversity disclosed by Hara et al., as the number of eigenvalues exceeding the threshold value changes depending on the angular spread and the delay spread, the number of branches of the subcarrier diversity is selected. Accordingly, it is necessary to provide FFT units and diversity combining units in the same numbers as the number of antennas at maximum. Additionally, a weight combining process, which includes eigen-decomposition prior to FFT, is necessary. Therefore, it does not necessarily mean that the post-FFT combining diversity disclosed by Hara et al. has a smaller circuit scale than that of the usual post-FFT combining diversity disclosed by Matsuoka et al.

### BRIEF SUMMARY OF THE INVENTION

According to an aspect of the present invention, there is provided a diversity receiver device comprising N antennas to receive orthogonal frequency-division signals; N digital filters to filter the signals received by the N antennas in order to reduce a delay spread of each of the signals received by the N antennas to obtain filtered signals; K (K≦N) beamforming units configured to subject the filtered signals to a beam combining process by using combining weights; a decomposition unit configured to subject the filtered signals to eigen-decomposition to generate N eigenvalues; a weight setting unit configured to select K eigenvalues in descending order from the generated N eigenvalues in order to set eigenvectors corresponding to the K eigenvalues to the beamforming units as the combing weight, respectively; K fast Fourier transformation (FFT) units configured to subject output signals of the beamforming units to fast Fourier transformation to obtain FFT signals; and a diversity combining unit configured to combine the FFT signals to generate a modulated signal.

### BRIEF DESCRIPTION OF THE SEVERAL VIEWS OF THE DRAWING

FIG. 1 is a block diagram of a diversity receiver device according to a first embodiment of the present invention.

FIG. 2 is a block diagram showing details of a diversity combining unit illustrated in FIG. 1.

FIGS. 3A to 3C illustrate examples of a delay profile under a multipath environment, a delay profile after being put through a digital filter and a delay profile after MMSE combining.

FIG. 4 is a block diagram showing a digital filter of another embodiment of the present invention.

FIG. 5 is a block diagram showing a digital filter of yet another embodiment of the present invention.

FIG. 6 illustrates an example of a delay profile under a multipath environment having a large delay spread.

FIG. 7 illustrates an example of a delay profile after MMSE combining in the case of using a reference signal, which loads a delayed wave with small delay time.

FIG. 8 is a block diagram of a diversity receiver device according to yet another embodiment of the present invention.

### DETAILED DESCRIPTION OF THE INVENTION

Hereinafter, embodiments of the present invention will be described in detail with reference to the accompanying drawings.

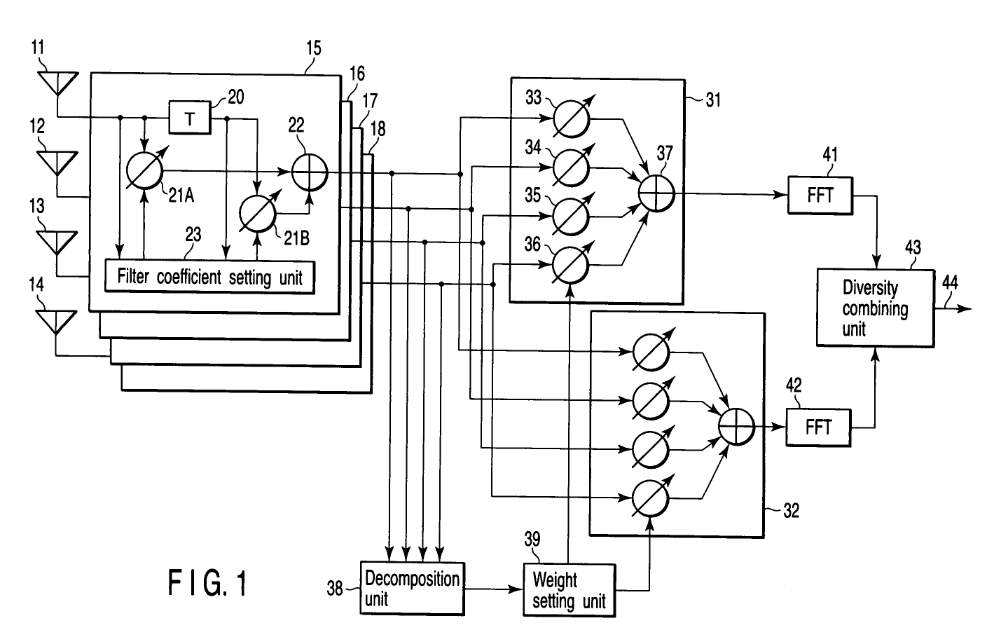

FIG. 1 is a diversity receiver device in accordance with a first embodiment of the present invention, which uses N=4 antennas in its example. Antennas 11 to 14 receive OFDM signals and output received signals. Received signals from antennas 11 to 14 are each transformed into digital signals by a radio frequency circuit and an analog to digital converter, which are not illustrated, and input to digital filters 15 to 18.

Digital filters 15 to 18 perform filter process in order to reduce the delay spread of received signals and enhance SNR or signal to interference ratio (SIR). Digital filters 15 to 18 in the example of FIG. 1 each has a tapped delay line (TDL) 20, multipliers 21A and 21B, an adder 22 and a filter coefficient setting unit 23. A portion comprising multipliers 21A and 21B and the adder 22 is referred to as a weighting adder.

Such digital filters 15 to 18 are also referred to as a finite impulse response (FIR) filter, a transversal filter or a matched filter.

At multipliers 21A and 21B, received signals from antennas 11 to 14 and output signals from the taps of TDL 20 are multiplied by a filter coefficient set by the filter coefficient setting unit 23. Output signals from multipliers 21A and 21B are added at the adder 22 and are output from digital filters 15 to 18. The filter coefficient setting unit 23 determines a filter coefficient from the received signals from antennas 11 to 14 and the output signals from TDL 20 and provides the filter coefficient to the multipliers 21A and 21B. The filter coefficient setting unit 23 calculates the filter coefficient for each antenna 11 to 14 individually. The calculation method of the filter coefficient will be explained in detail later on.

TDL 20 in FIG. 1 sets the number of taps L as 1, whereas L can also be a plural number. In a narrow-band communication system, when making a pseudo delay path model based on actual measurements, a 2 path fading model is frequently assumed. This is because time resolution accompanying band limiting is rough, and, further, because the approximation of the multiple delay paths are sufficiently available with 2 waves. Accordingly, by setting L=1, digital filters 15 to 18 can be realized as matched filters which reduce delay spread in a minimal circuit scale.

In this example, output signals from the digital filters 15 to 18 are input to a first beamforming unit 31 and a second beamforming unit 32.

The output signals from the digital filters 15 to 18 are given complex weighting by combining weight at multipliers 33 to 36 in the beamforming units 31 and 32, and are subsequently added by adder 37. From the beamforming units 31 and 32, output signals (beam output) corresponding to a plurality of received beams having different directivity (also called as eigen beam) can be obtained. The combining weight in the beamforming units 31 and 32 is set as follows.

Eigen-decomposition is applied to filtered signals from the digital filters 15 to 18 by an eigen-decomposition unit 38. The eigen-decomposition unit 38, for example, determines a 4-by-4 spatial correlation matrix of the received signal vectors given by the filtered signals of digital filters 15 to 18, then determines four eigenvalues λ1 to λ4 (λ1>λ2>λ3>λ4) and eigenvectors corresponding to eigenvalues λ1 to λ4. A weight setting unit 39 sets an eigenvector corresponding to the maximum eigenvalue λ1 as a combining weight for the first beamforming unit 31. Further, the weight setting unit 39 sets an eigenvector, which corresponds to the second largest eigenvalue λ2, as a combining weight for the second beamforming unit 32.

Output signals from the beamforming units 31 and 32 are each applied fast Fourier transformation (FFT) by FFT units 41 and 42 in order to be transformed into signals within the frequency domain, i.e., into subcarrier signals. Output signals from the FFT units 41 and 42 are input to a diversity combining unit 43, which carries out diversity combining for each subcarrier in order to reproduce data 44 that comes with the transmitted OFDM signal.

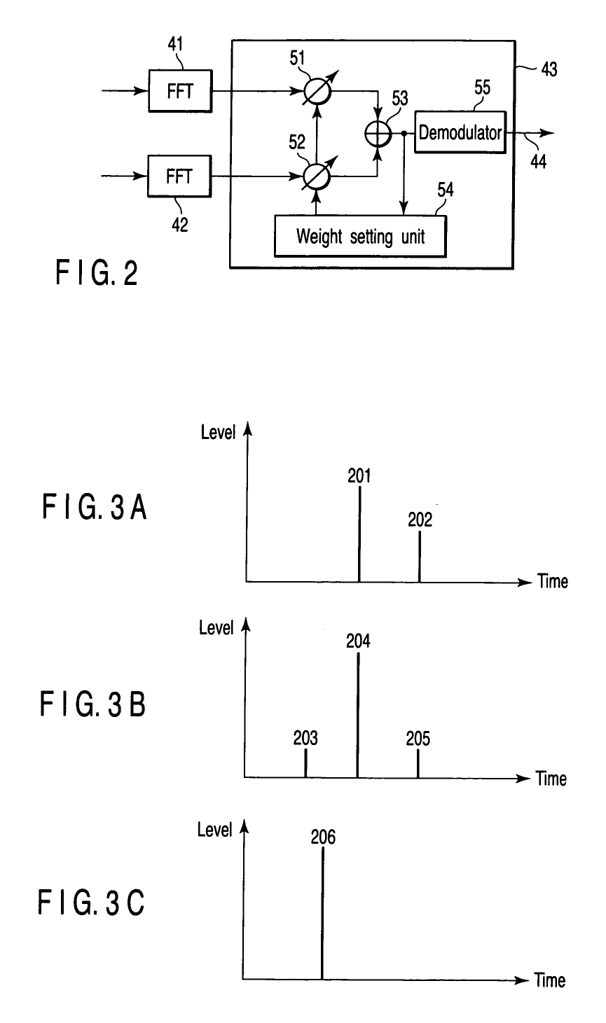

FIG. 2 shows a specific example of the diversity combining unit 43. A weight set by a weight setting unit 54 is multiplied on the output signals from the FFT units 41 and 42 in units of subcarriers at the multipliers 51 and 52. Output signals from multipliers 51 and 52 are added at an adder 53 and demodulated by a demodulator 55, from which reproduced data 44 is output.

In the diversity receiver device according to the present embodiment, the digital filters 15 to 18 gather energy of delay path component within the received signals for each antenna 11 to 14 in order to generate output signal with enhanced SNR. Next, by weight combining the output signals from the digital filters 15 to 18 by two eigenvectors respectively corresponding to the maximum eigenvalue and the second largest eigenvalue as combining weights at the beamforming units 31 and 32, a received beam with further improved SNR is formed. A post-FFT subcarrier combining diversity is performed on the output signals corresponding to each received beam from the beamforming units 31 and 32 by the FFT units 41 and 42 and diversity combining unit 43.

Accordingly, with two each of the FFT units 41 and 42 subsequent to the beamforming units 31 and 32 and the multipliers 51 and 52 within the diversity combining unit 43, in a composition less than the number of antennas 11 to 14, it is possible to realize the same performance as carrying out direct post-FFT combining diversity against received signals from four antennas. In other words, high reception performance with high diversity gain may be obtained while reducing the circuit scale considerably. Further, in some cases, other improvements, such as reducing power consumption and simplifying algorism, are also possible. In the example of FIG. 1, the N numbers of antennas 11 to 14 are shown as 4 and the number of beamforming units 31 and 32 are shown as 2. However, the number of antennas and beamforming units can be changed depending on the required quality improvement.

Next, a method to calculate the filter coefficient for the filter coefficient setting unit 23 in the digital filters 15 to 18 will be explained. The digital filters 15 to 18 form matched filters which, for example, use a correlation process of a received signal. As illustrated in FIG. 3A, when assuming a multipath propagation model having two path components 201 and 202, an ensemble mean of a value obtained by multiplying a complex conjugate x*(t) of received signal x (t) and signal x (t−τ), which x (t) is delayed for a time duration of τ, is taken.
y=E[x*(t)x(t−τ)] (1)

In this case, vector h=[1, y] shows the filter coefficient of the digital filters 15 to 18 for the multipath propagation. Here, by setting the weight for providing to multipliers 21A and 21B as h/|h|, a delay path is combined as illustrated in FIG. 3B. Here, |h| is a norm for vector h. In other words, when the path component 201 in FIG. 3A is a first arriving wave component and the path component 202 is a delayed wave component, a part of the path component 202's energy is gathered to the delayed time position of the path component 201, i.e., the position of path component 204 in FIG. 3B, by the digital filters 15 to 18. When the path component 204 in FIG. 3B is a desired component and the other path components 203 and 205 are undesired components, signal power of path component 204/signal power of (path component 203+path component 205) can be considered as an SNR with desired component. Accordingly, the SNR is improved by the digital filters 15 to 18.

In a code division multiple access (CDMA), only each delay path component is extracted at the receiving side. The delay path component is completely removed as these delay path components are combined in the same phase after receiving delay compensation. Meanwhile, when using OFDM as in the case of the present embodiment, (delay) interference component between samples remains at the receiving side. However, basically, in OFDM, there is no influence as the delay interference component is compensated for each subcarrier after FFT. Accordingly, when received signals possessing delay spread are output from antennas 11 to 14, the energy of a delayed wave component included in the received signal for each antenna is gathered in portions of certain delay time by the digital filters 15 to 18 in order to increase the SNR of desired wave.

As shown in the example of FIG. 1, in the case where TDL 20 has one tap, N eigenvalues close each other as the residual interference component becomes relatively large. For this reason, when carrying out subcarrier diversity only by the eigenvector beams corresponding to the maximum eigenvalue and the second largest eigenvalue, diversity gain is slightly lost. However, basically, as gain improvement by increasing combining reception from two to four branches is smaller than the diversity gain increase by increasing the reception from one to two combining branches, the advantage is maintained from a viewpoint of tradeoff between circuit complexity and performance.

In a broadband wireless communication system, as the sampling rate of an analog/digital conversion performed at the previous stage of the digital filters 15 to 18 is high, time resolution of the delay wave also becomes high, which appears as if there are many incoming delay paths. In such case, by increasing the number of taps L of the digital filters 15 to 18, scattered signal energy of received signals may be gathered. It is also effective in the case of an incoming delay wave with large delay time but the same time resolution.

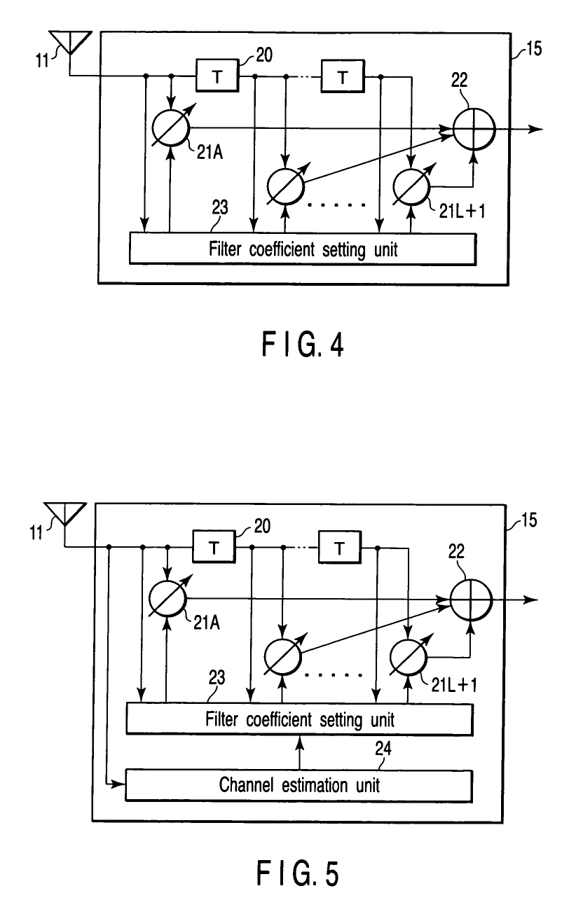

FIG. 4 shows another example of digital filter 15. The same applies to the other digital filters 16 to 18. In FIG. 1 the number of taps L is one, whereas, in FIG. 4, L is more than two. In this case, filter coefficient is determined as follows.

A complex conjugate x*(t) of received signal x (t) and a signal with x (t) delayed by iτ (i=1, . . . L−1) are multiplied in order to take an ensemble mean of such value.
yᵢ=E[x*(t)x(t−iτ)]

Where, vector h=[1, y₁, . . . , y_{L-1}] shows a matched filter coefficient of a multipath propagation. A weight to provide to the multiplier 21 of the digital filters 15 to 18 is determined as h/|h|. Thus, by setting the number of taps L to more than two, a delay wave component existing over more than two paths may be efficiently gathered.

FIG. 5 shows yet another example of digital filter 15. The same applies to the other digital filters 16 to 18. Even if the number of taps L is more than two as shown in FIG. 4, in some cases, a delay path does not exist in L pieces, or because P(P<L) delay paths are dominant, the levels of other delay paths are small. In such case, a digital filter shown in FIG. 5 is effective. In FIG. 5, a channel estimation unit is added.

The channel estimation unit 24 makes observations of delay time and approximate amplitude level possessed by the delay wave by estimating the channel response (delay profile of received signal). A filter coefficient setting unit 23 sets only the filter coefficient of a tap corresponding to delay time τ′p possessed by the delay wave observed by the channel estimation unit 24. Various methods for estimating delay profile have been suggested. A sliding correlation method is known as one of them, in which a given signal and a received signal are mutually shifted in terms of time while a correlation between both signals are taken. A method to estimate a delay profile by obtaining a channel response for each subcarrier in an FFT frequency domain and applying IFFT to the channel response of a frequency domain may also be used. Here, when vector h=[1, y₁, y₂, . . . , yₚ] is given to a correlation value of τ′p shown as follows, a filter coefficient, h/|h|, can be obtained.
yₚ=E[x*(t)x(t−τ′p)] (p=1, 2, . . . , P)

In order to recognize it as a delay path, a threshold Aₜₕ is arranged for an amplitude level, and only when the amplitude level of the delay profile exceeds Aₜₕ, a path is considered to exist in the position of a delay time of the delay profile, thus carrying out correlation process and calculation of a filter coefficient for the corresponding taps. Other taps may be given 0 as their filter coefficient. Alternatively, a switching process may be used to stop the operation of a corresponding process circuit and multiplier, i.e., to shut off the current to be put in.

Thus, by making the number of effective taps on the digital filter variable, even under communication environments where the propagation changes with time and the number of delay paths varies, all available delay wave components can be gathered efficiently while minimizing power consumption.

In another method to calculate a filter coefficient, a minimum mean square error (MMSE) algorithm is used in order to determine the filter coefficient so that the error between the received signal and reference signal is minimized. A reference signal is, for example, a pilot signal or a preamble signal, which is a known signal at the receiving side. By the use of MMSE algorithm, upon incident of received signals having delay spread for each antenna, each delay path component is suppressed for each antenna, thereby enabling in-phase combining of only the first arriving wave component. Thus, the influence by frequency selective fading for each antenna can be made equivalent to that by flat fading, thereby enabling the increase in the difference of all eigenvalues. In other words, signal energies included in the maximum eigenvalue and the second eigenvalue beams can be maximized, with which the diversity gain of a subcarrier combining can be increased. This can be understood by imaging the delay profile in FIG. 3A as the delay profile as shown in FIG. 3C. As for the examples of a specific algorithm of MMSE, there are sample matrix inversion (SMI) and least mean square (LMS).

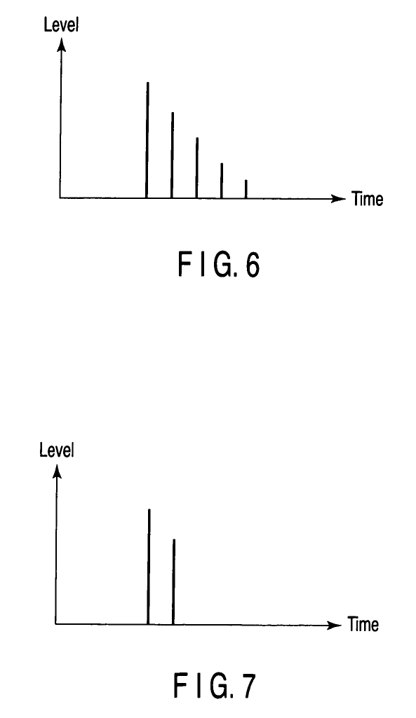

Even if some delay path remains as mentioned above, receiving performance for the OFDM signal is unchanged. For this reason, in some cases, it may rather be advantageous to load also the delay path component with large energy than to remove the delay path component completely and eliminate the energy of the desired wave component. This can be accomplished by carrying out training using a reference signal, which also includes multiple delay path components, by the MMSE algorithm. For example, this can be understood as carrying out MMSE combining by equalization using a reference signal, which loads delay waves with small delay time under a multipath environment having a large delay spread as shown in FIG. 6, in order to assume a delay profile as shown in FIG. 7. Here, the reference signal presumes a delay profile by utilizing a known symbol sequence, uses the obtained delay time and decay amount of each path, phase rotation amount and the like in order to make a replica combined with known signals.

### Second Embodiment

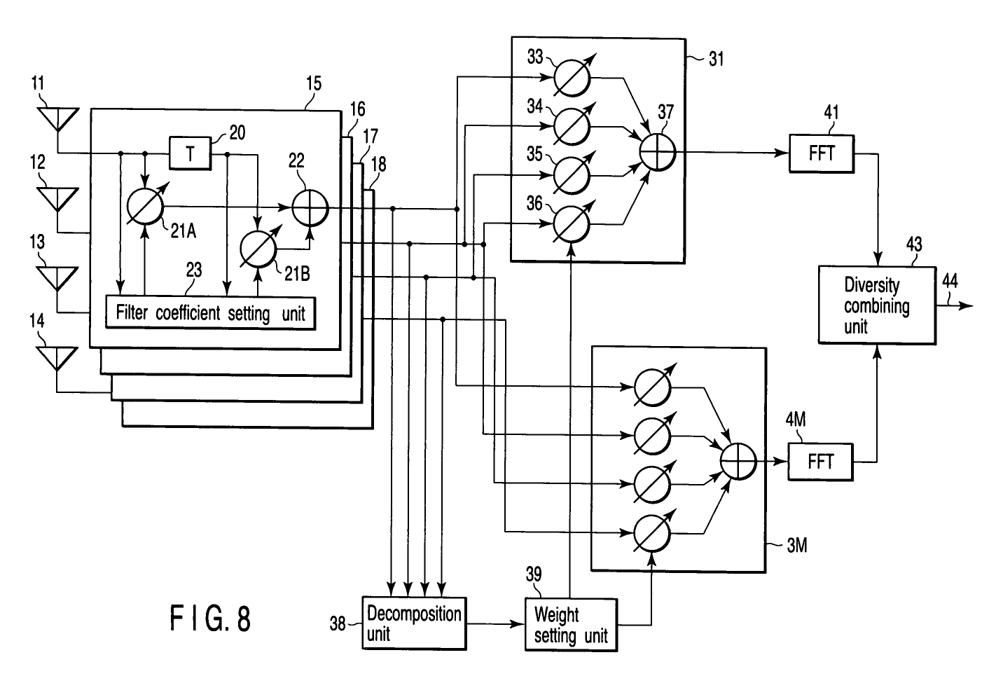

FIG. 8 is a diversity receiver device according to the second embodiment of the present invention, which differs from FIG. 1 in that it is equipped with M pieces (M>2) of beamforming units 31 to 3M. That is to say, output signals from digital filters 15 to 18 are input to beamforming units 31 to 3M. The beamforming units 31 to 3M each have multipliers 33 to 36 and an adder 37 likewise the beamforming units 31 and 32 in FIG. 1.

A weight setting unit 39 determines eigenvectors corresponding to eigenvalues λ1 to λ4 (λ1>λ2>λ3>λ4), which is determined by an eigenvalue decomposition unit 38, and sets an eigenvector corresponding to the maximum eigenvalue λ1 for the first beamforming unit 31 as a combining weight. Further, the weight setting unit 39 sets an eigenvector corresponding to the second largest eigenvalue λ2 for the beamforming unit 32 as a combining weight. Similarly, hereafter, an eigenvector corresponding to a Jth largest eigenvalue λJ is set for the Jth beamforming unit 3J as a combining weight.

Output signals from the beamforming units 31 to 3M are each applied fast Fourier transformation by FFT units 41 to 4M to be transformed into signals of the frequency domain, i.e., into subcarrier signals. A diversity combining unit 43 carries out diversity combining for each subcarrier for output signals from FFT units 41 to 4M in order to reproduce data 44.

Here, J is the number of eigenvalues exceeding threshold R and is a variable integer within the range of J<M. The weight setting unit 39 sets a total of J combing weight for the first to Jth beamforming units 31 to 3J, and sets (M−J) combining weight as 0 for the other beamforming units 3(J+1) to 3M. Instead of setting the (M−J) combining weight to 0, beamforming units 3(J+1) to 3M can be in an off-state, i.e., the power supply to beamforming units 3(J+1) to 3M can be turned off.

According to the foregoing second embodiment, by using J eigenbeam in cases where, for example, the eigenvalue dispersion is large, loss of energy can be minimized than in the case of selecting K pieces.

In the foregoing embodiment, the diversity receiver device is considered to be used as receiving terminals. However, it can also apply to a repeater device. This is because the output signals from each beamforming units 31 to 3M are OFDM signals with higher SNR than that of the received signals output from antennas 11 to 14. As one of the relay techniques for digital terrestrial broadcasting, a single frequency network (SFN), in which the same frequency is used for reception and transmission for relaying, is known. In the SFN repeater device, since an OFDM signal transmitted from the upper station (parent station) and the echo-back signal from the transmitting antenna of the repeater device are input via the receiving antenna, it is preferred that the transmitting signal from the transmitting antenna is output for retransmission after removing the echo-back component. That is to say that retransmission is performed after an operation to enhance the SNR is once conducted at the repeater device.

According to another method, in order to eliminate influences from the echo-back signal, the received OFDM signals are applied OFDM demodulation. Further, after applying error correcting decoding according to need, OFDM modulation is again applied in order to perform retransmission. In this method, a large delay (from approximately several hundred μsec to 1 msec), about the size of an effective symbol length corresponding to the FFT size of integrated service digital broadcasting (ISDB-T), occurs upon demodulation. Accordingly, as the retransmitted signal interferes with a signal, which arrives at the receiving side without coming through the repeater device, this method cannot be adopted for SFN. Consequently, it is required to improve SNR by an OFDM demodulation process, particularly without using an FFT process, only within the time domain, and, further, preferably by a method with small process delay and throughput. Such requirements can be met by using the precedent portion of the FFT unit as it is for the SFN repeater device in order to enable good relay amplification quality.

The diversity receiver device explained in the foregoing embodiments can be applied not only to the receiver for digital terrestrial broadcasting, but also to various wireless communication systems using OFDM, such as IEEE 802.11a and IEEE 802.11n, which are wireless LAN standard, {IEEE 802.16, which is conducted standards work for the specification for wireless metropolitan area network (MAN)}, and multi-carrier CDMA system and so forth. In either application, improvement in receiving quality as well as reduction in complexity can be realized.

As mentioned above, by the use of digital filters, the delay spread of received signals may be equivalently reduced, thereby increasing the variance of all eigenvalues. That is to say that since the energy of desired signals included in the beams of the maximum eigenvalue and the second eigenvalue can be maximized, diversity gain can be increased while the value of K is kept as small as possible. Hereby, good receiving performance can be realized with a small circuit scale.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A diversity receiver device comprising:
N antennas to receive orthogonal frequency-division signals;
N digital filters to filter the signals received the N antennas in order to reduce a delay spread of each of the signals received the N antennas to obtain filtered signals;
K (K≦N) beamforming units configured to subject the filtered signals to a beam combining process by using combining weights;
a decomposition unit configured to subject the filtered signals to eigen-decomposition to generate N eigenvalues;
a weight setting unit configured to select K eigenvalues in descending order from the generated N eigenvalues in order to set eigenvectors corresponding to the K eigenvalues to the beamforming units as the combing weights, respectively;
K fast Fourier transformation (FFT) units configured to subject output signals of the beamforming units to fast Fourier transformation to obtain FFT signals; and
a combining unit configured to combine the FFT signals to generate a modulated signal.

2. A diversity receiver device according to claim 1, wherein the weight setting unit selects eigenvalues exceeding a predetermined first threshold value among the N eigenvalues as the K eigenvalues.

3. A diversity receiver device according to claim 1, wherein the digital filters have tapped delay lines each having at least one tap, respectively, to delay the signals received by the N antennas, a filter coefficient setting unit configured to set filter coefficients to weighting-add the signals received by the N antennas and signals delayed by the tapped delay lines, and a weighting adder to weighting-add the signals received by the N antennas and the signals delayed using the filter coefficients.

4. A diversity receiver device according to claim 1, wherein the digital filters have tapped delay lines each having a plurality of taps to delay the signals received by the N antennas, a weighting adder to weighting-add the signals received by the N antennas and output signals from the plurality of taps in accordance with a predetermined filter coefficient, an estimation unit configured to estimate a channel response for each of the signals received by the N antennas in order to obtain a delay time and amplitude level of a delay wave included in each of the signals received by the N antennas, and a filter coefficient setting unit configured to change number of effective taps for the weighting adder in accordance with the delay time and amplitude level and set the filter coefficient to only output signals from the effective taps among the output signals from the plurality of taps.

5. A diversity receiver device according to claim 4, wherein the filter coefficient setting unit is configured to set a filter coefficient to 0 for a delayed signal by a tap of the plurality of taps which corresponds to the delay time of the delay wave with the amplitude level below a predetermined second threshold.

6. A diversity receiver device comprising:
N antennas to receive orthogonal frequency-division signals;
N digital filters to filter the signals received by the N antennas in order to maximize a signal-to-interference ratio of filtered signals obtained the digital filters;
K (K≦N) beamforming units configured to subject the filtered signals to a beam combining process by using combining weights;
a decomposition unit configured to subject the filtered signals to eigen-decomposition to generate N eigenvalues;
a weight setting unit configured to select K eigenvalues in descending order from the generated N eigenvalues in order to set eigenvectors corresponding to the K eigenvalues to the beamforming units as the combing weights, respectively; and
K fast Fourier transformation (FFT) units configured to subject output signals of the beamforming units to fast Fourier transformation to obtain FFT signals.

7. A diversity receiver device according to claim 6, wherein the weight setting unit selects eigenvalues exceeding a predetermined first threshold value among the N eigenvalues as the K eigenvalues.

8. A diversity receiver device according to claim 6, wherein the digital filters have tapped delay lines each having at least one tap, respectively, to delay the signals received by the N antennas, a filter coefficient setting unit configured to set filter coefficients to weighting-add the signals received by the N antennas and signals delayed by the tapped delay lines, and a weighting adder to weighting-add the signals received by the N antennas and the signals delayed using the filter coefficients.

9. A diversity receiver device according to claim 6, wherein the digital filters have tapped delay lines each having a plurality of taps to delay the signals received by the N antennas, a weighting adder to weighting-add the signals received by the N antennas and output signals from the plurality of taps in accordance with a predetermined filter coefficient, an estimation unit configured to estimate a channel response for each of the signals received by the N antennas in order to obtain a delay time and amplitude level of a delay wave included in each of the signals received by the N antennas, and a filter coefficient setting unit configured to change number of effective taps for the weighting adder in accordance with the delay time and amplitude level and set the filter coefficient to only output signals from the effective taps among the output signals from the plurality of taps.

10. A diversity receiver device according to claim 9, wherein the filter coefficient setting unit is configured to set a filter coefficient to 0 for a delayed signal by a tap of the plurality of taps which corresponds to the delay time of the delay wave with the amplitude level below a predetermined second threshold.

11. A diversity receiver device comprising:
N antennas to receive orthogonal frequency-division signals;
N digital filters to filter the signals received by the N antennas in order to maximize a signal-to-noise ratio of filtered signals obtained the digital filters;
K (K≦N) beamforming units configured to subject the filtered signals to a beam combining process by using combining weights;
a decomposition unit configured to subject the filtered signals to eigen-decomposition to generate N eigenvalues;
a weight setting unit configured to select K eigenvalues in descending order from the generated N eigenvalues in order to set eigenvectors corresponding to the K eigenvalues to the beamforming units as the combing weights, respectively; and
K fast Fourier transformation (FFT) units configured to subject output signals of the beamforming units to fast Fourier transformation to obtain FFT signals.

12. A diversity receiver device according to claim 11, wherein the weight setting unit selects eigenvalues exceeding a predetermined first threshold value among the N eigenvalues as the K eigenvalues.

13. A diversity receiver device according to claim 11, wherein the digital filters have tapped delay lines each having at least one tap, respectively, to delay the signals received by the N antennas, a filter coefficient setting unit configured to set filter coefficients to weighting-add the signals received by the N antennas and signals delayed by the tapped delay lines, and a weighting adder to weighting-add the signals received by the N antennas and the signals delayed using the filter coefficients.

14. A diversity receiver device according to claim 11, wherein the digital filters have tapped delay lines each having a plurality of taps to delay the signals received by the N antennas, a weighting adder to weighting-add the signals received by the N antennas and output signals from the plurality of taps in accordance with a predetermined filter coefficient, an estimation unit configured to estimate a channel response for each of the signals received by the N antennas in order to obtain a delay time and amplitude level of a delay wave included in each of the signals received by the N antennas, and a filter coefficient setting unit configured to change number of effective taps for the weighting adder in accordance with the delay time and amplitude level and set the filter coefficient to only output signals from the effective taps among the output signals from the plurality of taps.

15. A diversity receiver device according to claim 14, wherein the filter coefficient setting unit is configured to set a filter coefficient to 0 for a delayed signal by a tap of the plurality of taps which corresponds to the delay time of the delay wave with the amplitude level below a predetermined second threshold.
